(19) United States
(12) Patent Application Publication
(10) Pub. No.: US 2016/0290716 A1
(43) Pub. Date: Oct. 6, 2016

(54) COMMERCIAL LAUNDRY DRYER ENERGY RECOVERY SYSTEM

(71) Applicant: AIR ENTERPRISES LLC (AIR ENTERPRISES ACQUISITION LLC), Akron, OH (US)

(72) Inventor: Robert L. Kurtz, JR., Barberton, OH (US)

(73) Assignee: Air Enterprises LLC (Air Enterprises Acquisition L LC), Akron, OH (US)

(21) Appl. No.: 15/034,975

(22) PCT Filed: Aug. 12, 2015
(86) PCT No.: PCT/US15/44777

§ 371 Date: May 6, 2016

Related U.S. Application Data
(60) Provisional application No. 62/111,203, filed on Feb. 3, 2015.
(60) Provisional application No. 62/037,818, filed on Aug. 15, 2014.

(51) Int. Cl. F26B 23/00; D06F 58/20

(52) U.S. Cl. CPC F26B 23/002; D06F 58/20

(57) ABSTRACT

An energy recovery system and method for laundry systems that transfers heat from warm exhaust air to intake air. The system and method includes a thermal wheel adapted to absorb heat from an exhaust air stream and discharge heat to an intake air stream for preheating the intake air. The system and method further includes a lint management system for clearing or otherwise managing lint buildup on the thermal wheel, and a bypass damper for admitting non-preheated intake air, particularly for use during a cooldown cycle.

### BACKGROUND

This disclosure relates to a system and method for recovering heat from a laundry dryer. While the disclosure is particularly directed towards heat recovery from commercial dryers, and thus will be described with specific reference thereto, it will be appreciated that this disclosure may have usefulness in other fields and applications.

Many laundry dryers operate by circulating heated air around laundry to be dried. Ambient air is first drawn into the dryer, heated by a heating element (resistive electric element, gas burner, etc.) to a prescribed temperature, and then circulated around the laundry to effect drying. The moisture-laden hot air is then exhausted to the atmosphere. Virtually all of the thermal energy in the exhaust air is lost when such air is discharged to the environment.

It is known to use a heat exchanger to recover heat from hot exhaust flows. For example, U.S. Pat. No. 4,095,349 discloses a heat exchange unit which is adapted to utilize the heat contained in the lint and moisture laden exhaust gases discharged from a commercial clothes dryer to preheat clean, ambient air which is introduced into the dryer in advance of, or at the heating unit thereof, for reducing the amount of energy required to operate the dryer.

However, the prior art approaches to recovering heat from dryer exhaust streams have suffered from one or more drawbacks. Many designs fail to achieve substantial energy savings due to a variety of deficiencies.

### SUMMARY

The present disclosure sets forth an energy recovery system and method for laundry systems that transfers heat from warm exhaust air to intake air. The system and method includes a thermal wheel adapted to absorb heat from an exhaust air stream and discharge heat to an intake air stream for preheating the intake air. The system and method further includes a lint management system for clearing or otherwise managing lint buildup on the thermal wheel, and a bypass damper for admitting non-preheated intake air, particularly for use during a cooldown cycle.

In accordance with one aspect, an energy recovery system for use with a heated air dryer comprises a heat exchanger adapted to transfer thermal energy from an exhaust output air flow of an associated dryer to an intake air flow via a thermal media, the intake air flow being thereby preheated and directed to an intake of the associated dryer, a selectively openable damper for bypassing intake air around the heat exchanger, and a controller in communication with the heat exchanger and the damper for controlling operation of same.

The heat exchanger can include a thermal wheel. The thermal wheel can include thermal media having a plurality of flutes, each flute defining a flow passageway extending axially through the thermal wheel. The flow passageway can be straight and extend parallel to an axis of rotation of the thermal wheel. The thermal media can have between 7 and 11 flutes per inch. The thermal media can be coated with epoxy. The heat exchanger can include a housing in which the thermal wheel is supported for rotation, and the flow of at least one of the exhaust air flow or intake air flow through the housing can be at a rate less than 800 feet per minute. The selectively openable damper can be actuated by at least one of an electric motor, a solenoid or a pneumatic actuator, the selectively openable damper operative to, when open, supply non-preheated intake air to the intake of the associated dryer. The system can further include a debris management system for purging accumulated debris from the heat exchanger, the debris management system being configured to direct compressed air towards at least one side of the heat exchanger to clean the heat exchanger during operation. The controller can be operatively connected to the debris management system for selectively operating the debris management system. The system can include at least one monitor for monitoring at least one aspect of the heat exchanger, the monitor operatively connected to the controller.

The at least one monitor includes a differential pressure switch for detecting pressure in the exhaust and/or intake air flows, or a rotation sensor for sensing rotation of the thermal wheel.

In accordance with another aspect, a method of recovering heat from an exhaust of a heated air dryer comprises transferring thermal energy from an exhaust output air flow of the dryer to an intake air flow via a heat exchanger including a rotating thermal media, the intake air flow being thereby preheated and directed to an intake of the dryer, and selectively opening a damper for bypassing intake air around the heat exchanger to assist in a dryer cool down function.

The method can further comprise controlling the damper with a controller configured to open and close the damper. The method can also include activating a lint management system configured to direct compressed air at a surface of the rotating media to dislodge lint particles therefrom. The method can include monitoring a differential pressure associated with the flow of air through the rotating media and, when the differential pressure exceeds a threshold value, activating the lint management system. The method can also include activating the lint management system at prescribed intervals based at least in part on a total run time of the rotating media.

### BRIEF DESCRIPTION OF THE DRAWINGS

The presently described embodiments exist in the construction, arrangement and combination of the various parts of the device and steps of the method whereby the objects contemplated are attained as hereinafter more fully set forth specifically pointed out in the claims and illustrated in the accompanying drawings in which:

FIG. 1 is a block diagram of an exemplary dryer and energy recovery system in accordance with the present disclosure;

FIG. 2 is a block diagram of an exemplary dryer energy recovery unit in accordance with the present disclosure;

FIG. 3 is a perspective view of an the dryer energy recover unit;

FIG. 4 is another perspective view of the dryer energy recovery unit;

FIG. 5 is a flowchart of an exemplary method in accordance with the present disclosure;

FIG. 6 is a schematic diagram of an exemplary lint management system in accordance with the present disclosure.

### DETAILED DESCRIPTION

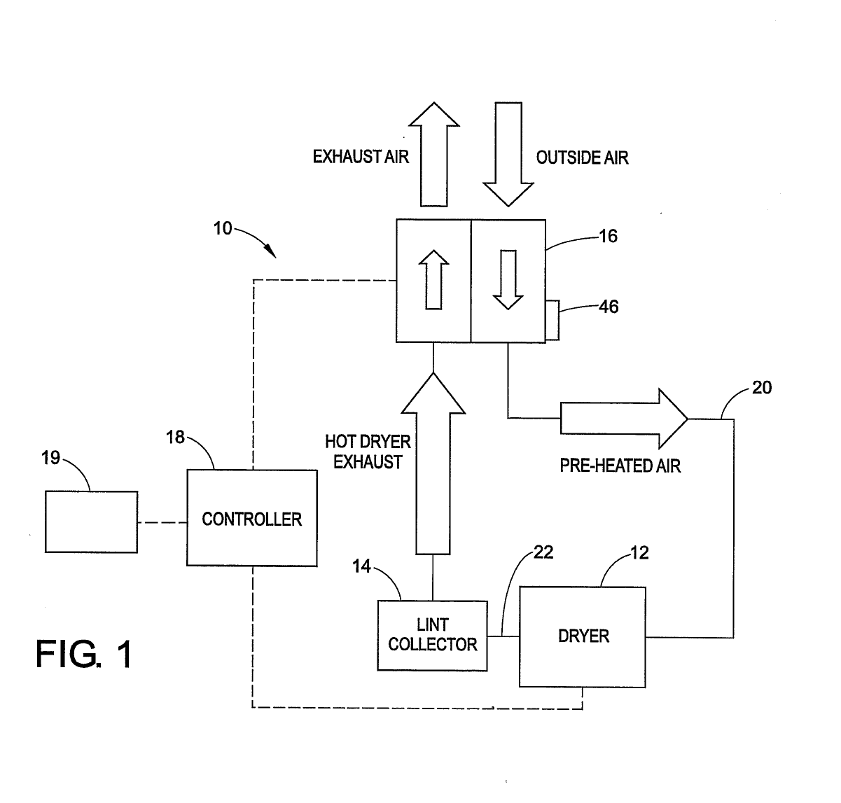

Referring now to the drawings wherein the showings are for purposes of illustrating the disclosed embodiments only and not for purposes of limiting the same, FIG. 1 shows one embodiment of an exemplary system in accordance with the present disclosure. The system 10 generally comprises a dryer 12, a lint collector 14, a dryer energy recovery unit 16, and a controller 18 operatively connected to the dryer 12 and the dryer energy recovery unit 16.

It will be appreciated that aspects of the present disclosure can be implemented in virtually any setting and with virtually any dryer that is configured to heat an intake air supply and exhaust moisture laden hot air. Accordingly, the present disclosure is not limited to any particular type of dryer, but will be described in connection with a laundry dryer. Aspects of the present disclosure are also applicable to a wide range of processes similar to drying wherein hot air or gas is exhausted, and intake air or gas is to be heated. Such other other types of processes besides drying can include certain chemical processes, food preparation processes such as baking, etc.

When a drying cycle is initiated, the dryer draws in outside air through the dryer energy recovery unit 16 via intake duct 20. The outside air is heated by the heating element of the dryer and then circulated about the laundry in a conventional fashion. The exhaust air, typically moisture-laden and containing lint, is exhausted via discharge duct 22. In the illustrated embodiment, an inline lint collector 14 separates lint from the exhaust air as it travels to the dryer energy recovery unit 16. The lint collector 14 typically will not remove all of the lint from the exhaust air, but will substantially reduce the amount of lint that travels to the dryer energy recovery unit 16. For example, a properly designed and maintained lint collector can remove up to 90% of the lint leaving the dryer 12 as the exhaust air travels to the dryer recovery unit 16. The lint collector 14 can include a screen or filter type collector, and/or a cyclonic lint collector, for example. A wide variety of lint collectors exist and can be used in conjunction with the other aspects of the present disclosure.

As the exhaust air enters the dryer energy recovery unit 16, heat is transferred from the hot exhaust air via the energy recovery media to the outside air entering the heat exchanger 16. This serves to pre-heat the outside air, while reducing the temperature of the exhaust air exiting the heat exchanger 16. Accordingly, the air supplied to the dryer 12 via intake duct 20 is at a higher temperature than the outside air, thus decreasing the amount of energy required to heat the air to the dryer operating specifications. In this manner, the amount of energy required to operate the dryer 12 can be greatly reduced.

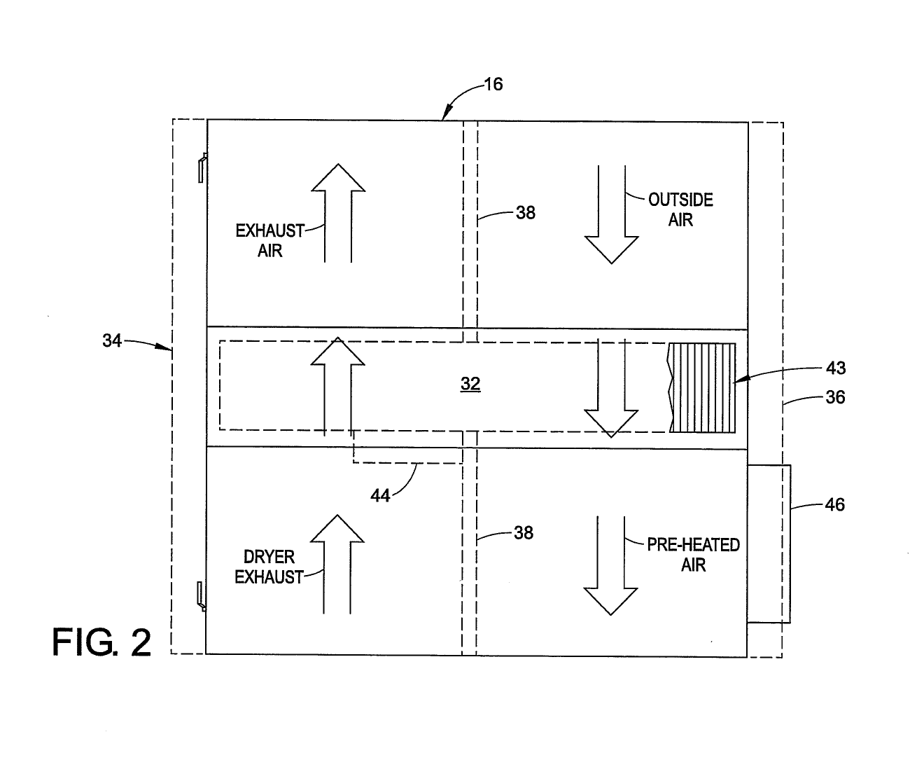

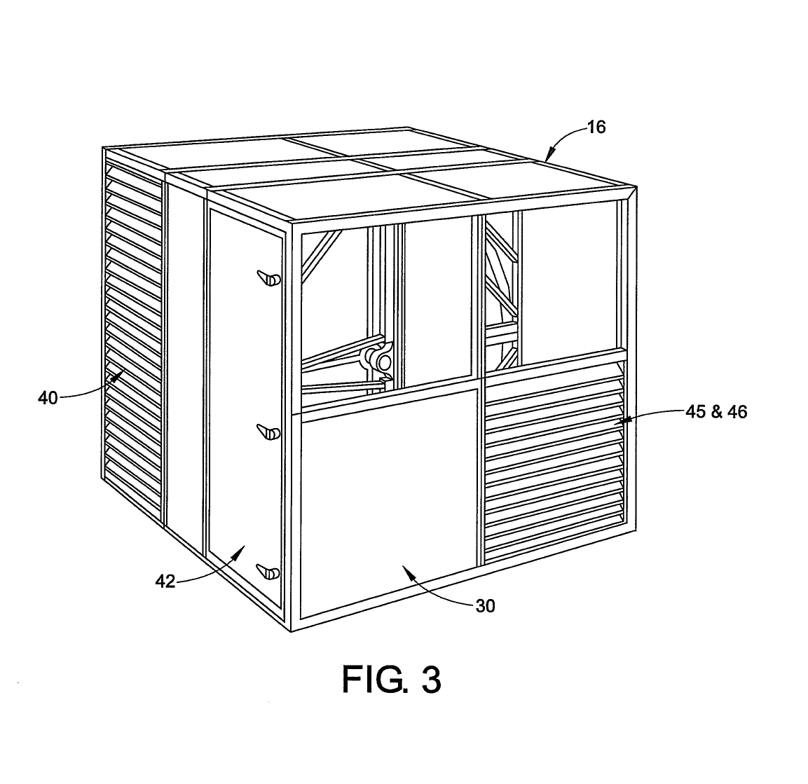

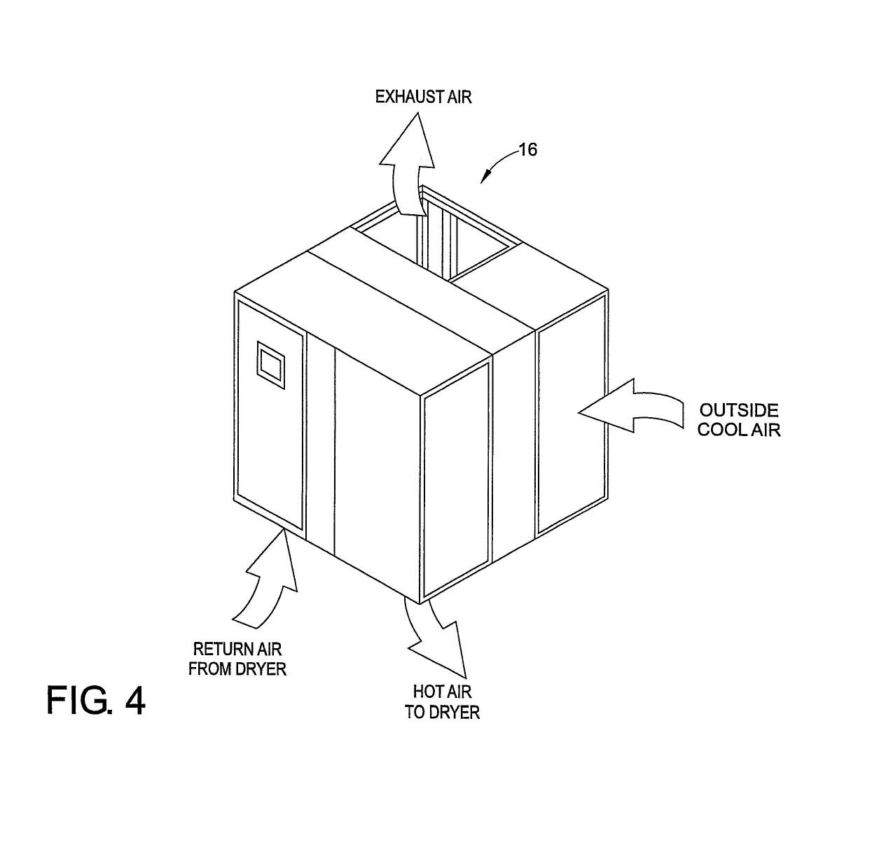

Turning to FIGS. 2-4, the exemplary dryer energy recovery unit 16 is illustrated in detail. In the exemplary embodiment, the dryer energy recovery unit 16 includes a housing 30 in which a rotating heat exchanger 32 is supported. The rotating heat exchanger can be a thermal wheel, such as the thermal wheel manufactured by Thermotech Enterprises, Inc., of Tampa Fla., and/or described in U.S. Pat. No. 6,422,299, which is hereby incorporated by reference in its entirety. The housing 30 is divided into an exhaust section 34 and an intake section 36. Partition walls 38 and seals (not shown) separate the respective intake and exhaust air flows.

As will be appreciated, air (exhaust or intake) is configured to pass through the heat exchanger in a direction parallel to the axis of rotation. In FIG. 2, the axis of rotation of the rotating heat exchanger 32 is parallel to the plane of the drawing. As such, the rotating heat exchanger 32 is supported in a central position within the housing 30, generally bisecting the exhaust section 34 and the intake section 36. The housing 30 is configured to accept a variety of ductwork to route the hot exhaust air into the exhaust section 34 and to route the outside air into the intake section 36. For example, ducting can be connected to one or more adjacent sides of the intake/exhaust sections, as well as a top or bottom thereof.

The housing 30 includes intake and exhaust plenums 40 that facilitate full size access doors 42 for inspection, cleaning and maintenance. The large plenum and connections (ductwork) allow for airflow velocity reduction as the respective air flows enter the unit 16. This allows for better distribution of even airflow velocity across the wheel face for improved heat transfer. It should be appreciated that flow rates will vary based on the dryer fan design and/or the size of the dryer energy recovery unit of a given application. In one embodiment, a maximum of 800 feet per minute (fpm) face velocity through the wheel has been found to give desired performance.

It should be appreciated that the thermal wheel size enables lower face velocity at the wheel face which provides improved and more consistent heat transfer as the air passes through the wheel. In addition, the lower face velocity results in less impact of lint on the wheel surface. It has been found that slower moving lint has an increased ability to pass through the thermal wheel without catching on the face thereof. Thus, by sizing the system to have a maximum 800 fpm face velocity, lint clogging can be minimized.

To further improve the ability of lint to pass through the thermal wheel, the flute size of the wheel media has been increased over the conventional size utilized in thermal wheels used in the HVAC industry. In one embodiment, the thermal wheel media is approximately 8 inches thick and has approximately 7.5-10.5 flutes per inch (as compared to 12-15 flutes per inch for HVAC applications). This allows for easier pass through of smaller lint particles. The flute design also allows for straight pass through channels so that lint does not catch as it passes through the media. That is, unlike existing thermal wheel media which may have nonlinear flutes or passages, the thermal wheel media of the present disclosure includes flutes having a clear line of sight through from one side to the other. This is illustrated, for example, in FIG. 2 wherein a portion of the thermal wheel 32 is shown with flute passageways 43 superimposed thereon.

To further restrict the buildup of lint, the thermal wheel energy recovery media can be coated or treated with a material to reduce friction and/or provide a smooth surface to inhibit lint collection. In one embodiment, the thermal wheel media is an epoxy coated aluminum foil. The entire depth of the wheel material (foil material) can be epoxy coated, including the surfaces and edges of the foil. The coating helps to allow lint to pass through without catching of rough surfaces/edges.

Despite the operation of the lint collector and the improved pass through of lint particles resulting from the larger flute size and coating wheel media, lint may still collect on the face of the thermal wheel over time, or within the flutes themselves. Accordingly, the present disclosure sets forth a debris management system that is configured to clean the entire face of the thermal wheel while the wheel is rotating. As will be described, the debris management system operates periodically to remove any debris, which in the illustrated embodiment is lint, that has accumulated on the thermal wheel.

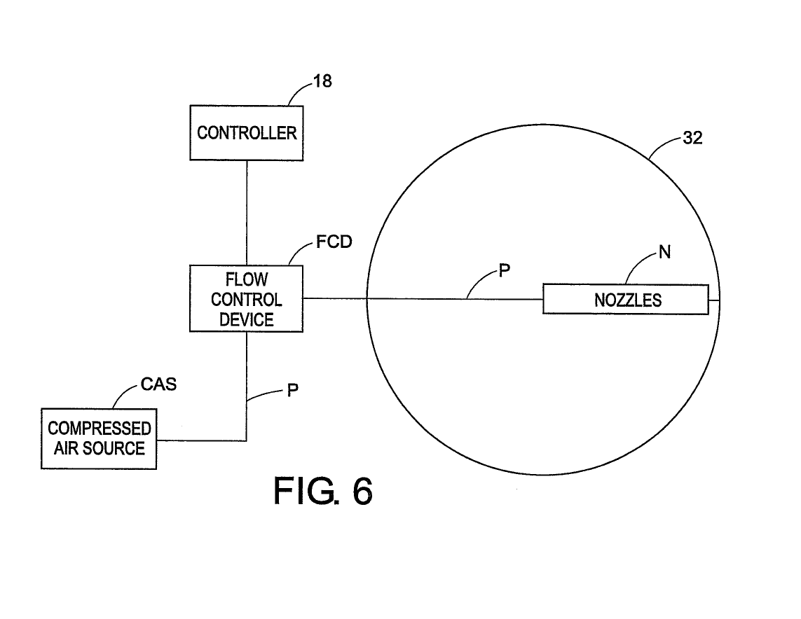

Returning to FIG. 2, and with additional reference to FIG. 6, the debris management system, in the form of lint management system (LMS) 44, is configured to direct compressed air on the face of the thermal wheel to dislodge and/or force accumulated lint through the flutes. In one embodiment, the LMS 44 comprises a plurality of a passageways P, nozzles N, openings, etc. for directing compressed air towards the face of the thermal wheel 32. The compressed air can be supplied from a local plant compressed air source CAS, or a standalone compressor, for example. It will be appreciated that, depending on the configuration of the LMS 44, any accumulated lint will be blown off of or through the wheel media from the upstream side, downstream side, or both sides.

The LMS 44 of the illustrated embodiment is installed in the upstream side of the exhaust section 34 of the housing 30. The flow control device FCD, which can be an air solenoid valve or other suitable device, is configured to restrict or permit the flow of compressed air from compressed air source CAS to the one or more passageways P, nozzles N, etc. such that lint removal can be performed on demand by opening or closing such valve. In the case of a solenoid valve, the controller 18 can be configured to open and close the valve to effect a lint cleaning cycle be sending a control signal thereto. In one arrangement, the FCD may be a normally closed valve that may be opened when commanded by the controller 18, but otherwise remains closed. In some configurations, the FCD can be configured to rapidly open and close to pulse air to enhance lint removal. In some embodiments, the LMS 44 can include an air blade (e.g., a long narrow passageway through which compressed air can flow) for directing compressed air at the surface of the thermal wheel 32.

In one exemplary configuration, an output signal indicating dryer cycle startup is sent from the dryer to the controller 18. This input will activate the unit 16 to enter start mode—e.g., the thermal wheel 32 will ramp up to speed (for example, 8 rpm (adjustable)) via a variable frequency drive and will continue to run at this rpm until the output signal from the dryer indicates that the dryer cycle is complete. When the wheel reaches its prescribed speed, a timer associated with the LMS 44 is started. The controller 18 will then open the air solenoid valve to operate after a prescribed period of time for a prescribed duration. In one embodiment, the LMS 44 is activated every 5 minutes for a duration of 15 seconds. Meanwhile, the thermal wheel continues to run at the set rpm. The LMS 44 will continue to cycle on/off every 5 minutes until the dryer cycle is completed. When the output signal from the dryer changes to indicate that the dryer cycle is complete, the LMS air solenoid can be activated for 15 seconds (adjustable) and then deactivated. The wheel will then slow to 0 rpm and the controller will reset to startup mode.

The LMS 44 can also be manually activated. In one embodiment, a push button is provided to activate the LMS 44 manually. When the push button is depressed, the controller will ramp up the thermal wheel to speed (if not already spinning), and then open the air solenoid valve for a prescribed amount of time (e.g., 15 seconds (adjustable) while the wheel continues to run. The controller may then wait for two minutes (adjustable) to allow for the compressed air source to recharge, and then open the solenoid valve again for 15 seconds (adjustable). The system then can return to startup mode to await the next dryer cycle.

The LMS 44 can further include a downstream component that works in conjunction with the upstream components to direct compressed air towards the downstream face of the thermal wheel. In one embodiment, the upstream and downstream components can alternate operation to alternately remove lint from either side of the thermal wheel.

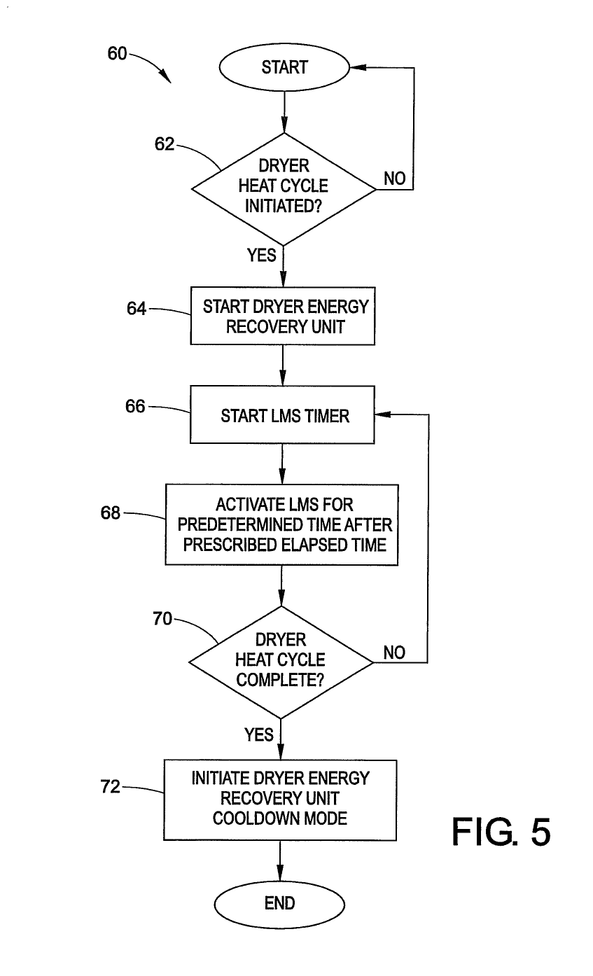

Turning to FIG. 5, a flow chart illustrates one exemplary method 60 in which the dryer energy recovery unit 16 can be implemented. The method begins with process step 62 wherein it is determined whether a dryer heat cycle has been initiated. In one exemplary configuration, an output signal indicating dryer heating cycle startup is sent from the dryer 12 to the controller 18. Controller 18 is configured to initiate the dryer energy recovery unit 16 in response to the output signal from the dryer 12 indicating heating cycle startup. Accordingly, the controller 18 sends a signal to unit 16 to enter start mode—e.g., the thermal wheel 32 will ramp up to speed (for example, 8 rpm (adjustable)) via a variable frequency drive and will continue to run at this rpm until the output signal from the dryer indicates that the dryer heating cycle is complete. When the thermal wheel 32 reaches its prescribed speed, a timer associated with the LMS 44 is started in process step 66. After a prescribed amount of time, the LMS 44 is activated for a predetermined length of time in process step 68. For example, the controller 18 can signal an air solenoid valve to operate after a prescribed period of time for a prescribed duration to thereby direct compressed air at the thermal wheel 32 as described above. In one exemplary embodiment, the LMS 44 is activated every 5 minutes (adjustable) for a duration of 15 seconds (adjustable). Meanwhile, the thermal wheel 32 continues to run at the set rpm. In process step 70, it is determined whether the dryer remains in the heat cycle, or whether the heat cycle has terminated and the dryer has entered a cool down mode. If the dryer 12 remains in the heat cycle, the method reverts to process step 66 and the LMS 44 will continue to cycle on/off every 5 minutes (adjustable) until the dryer cycle is completed.

When the output signal from the dryer 12 changes to indicate that the dryer heating cycle is complete, the method continues to process step 72 and the dryer energy recovery unit 16 enters a cooldown mode. In one embodiment, the LMS air solenoid can be activated for 15 seconds (adjustable) and then deactivated just prior to the unit 16 entering the cooldown mode. The wheel 32 will then slow to 0 rpm and the system will standby for the next dryer heat cycle to begin.

As the dryer heating cycle completes, controller 18 will communicate with the unit 16 to initiate the cool down cycle mode. In this mode, the normally closed damper 46 (see FIGS. 1 and 2) is opened to allow direct outside air to be drawn into the dryer without having to pass through the energy recovery media of the heat exchanger 32. That is, damper 46, when open, allows outside air to flow directly to the dryer without preheating.

When the output signal from the dryer changes to indicate that the dryer cool down cycle is complete, the damper 46 is returned to its normally closed position. The energy recovery wheel 32, LMS 44 and associated controls generally will not be active during the cooldown cycle.

Various safety devices and/or monitors 19 (See FIG. 1) can be provided to enhance system performance. In some embodiments, such safety devices and/or monitors can be configured to generate visual and/or audible alarms in the event of a monitored failure.

In one embodiment, the safety devices and/or monitors 19 can include a differential pressure switch or sensor provided for monitoring a pressure differential across the energy recovery media of the heat exchanger 32. The differential pressure switch or sensor can be set to alarm at a prescribed pressure, for example 1″ water gauge (adjustable) pressure differential. When the prescribed pressure differential is detected, an indicator or alarm can be triggered to indicate that a potential plugging of the media of the thermal wheel has begun, and the LMS 44 should be activated (either automatically or manually).

In another exemplary embodiment, a rotation sensor can be connected to the rotating energy recovery media device (e.g., thermal wheel). In the event that the wheel has stopped rotating due to electrical or mechanical failure, an alarm can be generated. Either of these two failure events will generally require manual inspection and corrective action in order to continue with operation of the energy recovery unit.

It should be appreciated that the energy recovery system and methods disclosed herein provide significant energy savings. In an exemplary test case, energy savings in excess of 40% is realized.

The above description merely provides a disclosure of particular embodiments of the claimed invention and is not intended for the purposes of limiting the same thereto. As such, this disclosure is not limited to only the above described embodiments, rather it is recognized that one skilled in the art could conceive alternative embodiments that fall within the scope of the invention.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An energy recovery system for use with a heated air dryer, the energy recovery system comprising:
a heat exchanger adapted to transfer thermal energy from an exhaust output air flow of an associated dryer to an intake air flow via a thermal media, the intake air flow being thereby preheated and directed to an intake of the associated dryer;
a selectively openable damper for bypassing intake air around the heat exchanger; and
a controller in communication with the heat exchanger and the damper for controlling operation of same.

2. The system of claim 1, wherein the heat exchanger includes a thermal wheel.

3. The system of claim 2, wherein the thermal wheel includes a thermal media having a plurality of flutes, each flute defining a flow passageway extending axially through the thermal wheel.

4. The system of claim 3, wherein the flow passageway is straight and extends parallel to an axis of rotation of the thermal wheel.

5. The system of claim 4, wherein the thermal media has between 7 and 11 flutes per inch.

6. The system of claim 7, wherein the thermal media is coated with epoxy.

7. The system of claim 6, wherein the heat exchanger includes a housing in which the thermal wheel is supported for rotation, and wherein the flow of at least one of the exhaust air flow or intake air flow through the housing is at a rate less than 800 feet per minute.

8. The system of claim 1, wherein the selectively openable damper is actuated by at least one of an electric motor, a solenoid or a pneumatic actuator, the selectively openable damper operative to, when open, supply non-preheated intake air to the intake of the associated dryer.

9. The system of claim 1, further comprising a debris management system for purging accumulated debris from the heat exchanger, the debris management system being configured to direct compressed air towards at least one side of the heat exchanger to clean the heat exchanger during operation.

10. The system of claim 1, wherein the controller is operatively connected to the debris management system for selectively operating the debris management system.

11. The system of claim 10, further comprising at least one monitor for monitoring at least one aspect of the heat exchanger, the monitor operatively connected to the controller.

12. The system of claim 11, wherein the at least one monitor includes a differential pressure switch for detecting pressure in the exhaust and/or intake air flows, or a rotation sensor for sensing rotation of the thermal wheel.

13. The system of claim 1, further comprising the associated dryer in fluid communication with the heat exchanger.

14. A method of recovering heat from an exhaust of a heated air dryer comprising:
transferring thermal energy from an exhaust output air flow of the dryer to an intake air flow via a heat exchanger including a rotating thermal media, the intake air flow being thereby preheated and directed to an intake of the dryer; and
selectively opening a damper for bypassing intake air around the heat exchanger to assist in a dryer cool down function.

15. The method of claim 14, further comprising controlling the damper with a controller configured to open and close the damper.

16. The method of claim 14, further comprising activating a lint management system configured to direct compressed air at a surface of the rotating media.

17. The method of claim 16, further comprising monitoring a differential pressure associated with the flow of air through the rotating media and, when the differential pressure exceeds a threshold value, activating the lint management system.

18. The method of claim 16, further comprising activating the lint management system at prescribed intervals based at least in part on a total run time of the rotating media.
